(19) United States
(12) Patent Application Publication
(10) Pub. No.: US 2022/0099257 A1
(43) Pub. Date: Mar. 31, 2022

(54) LIGHT STRING WITH MULTIPLE PARALLEL WIRES AND METHOD OF MANUFACTURING LIGHT STRING WITH MULTIPLE PARALLEL WIRES

(71) Applicant: DONGGUAN HAOTUO OPTOELECTRONICS TECHNOLOGY CO., LTD., Dongguan (CN)

(72) Inventor: Qiming Liu, Putian (CN)

(21) Appl. No.: 17/037,788

(22) Filed: Sep. 30, 2020

(51) Int. Cl. F21S 4/10; F21V 19/00

(52) U.S. Cl. CPC F21S 4/10; F21Y 2115/10; F21V 19/0025

(57) ABSTRACT

The present disclosure provides a light string with multiple parallel wires and a method of manufacturing the light string with multiple parallel wire. The light string includes a positive wire disposed axially and a negative wire disposed in parallel with the positive wire. Positive solder joints and first disconnection points are disposed on the positive wire. Negative solder joints and second disconnection points are disposed on the negative wire. A welding lamp area is formed by a positive solder joint and a negative solder joint. An LED lamp bead is attached to a front or a side of the welding lamp area. The first disconnection points and the second disconnection points are staggered, such that LED lamp beads disposed between the positive wire and the negative wire are serial-parallel connected.

### TECHNICAL FIELD

The present disclosure relates to a field of lamps, in particular to a light string with multiple parallel wires and a method of manufacturing the light string with multiple parallel wires

### BACKGROUND

Nowadays, people's living standards are gradually improving. In holidays and daily life, light strings are suspended for decoration, which greatly increases a demand for decorative lights. At present, the holiday light string still adopts a conventional structure. For example, the Chinese patent application numbered CN201520607108.7 discloses a holiday light string that generally comprises a light string main body composed of several electric wires, LEDs, and lampshades, etc. The light string requires to make terminal and wind the electric wires manual, etc. Each process is completed manually, which is high in labor costs and labor intensity. Moreover, the production difficulty is increased, the production efficiency is reduced, and the production efficiency of the entire light string is finally affected.

In order to meet market demands, the production of light strings is getting faster and faster. The applicant proposed an application of an enameled copper wire LED light string numbered CN201620043393.9 and an application of an X flexible wire LED light string numbered CN201620043391. LED driving circuits of above mentioned light stings adopt low-voltage LED constant current driving technologies. However, if any of the above light string is applied to a 220V AC power supply, a solution that multiple LED lamps connect in series must be used. As shown in FIG. 4, when multiple LED lamps are connected in series, power dissipation of the LED lamps becomes larger due to instability of the current, which usually leads to damage of the driving circuit of the LED lamps. In addition, costs are correspondingly increased, or, a strength of an AC/DC power supply portion must be increased to provide a lower DC voltage, which greatly increases the costs.

In summary, there are still many defects in the prior art, which need to be further improved.

### SUMMARY

In order to solve above problems, the present disclosure provides a light string with multiple parallel wires that is able to be applied to 3V low-voltage power supply occasions, and also able to be applied to 110V or 220V AC power supply occasions and is suitable for automated production, and the present disclosure provides a method of manufacturing the light string with multiple parallel wires.

In order to achieve the above objects, the present disclosure provides a light string with multiple parallel wires. The light string comprises a positive wire disposed axially and a negative wire disposed in parallel with the positive wire. A plurality of positive solder joints and first disconnection points are disposed on the positive wire. A plurality of negative solder joints corresponding to the positive solder joints and second disconnection points corresponding to the first disconnection points are disposed on the negative wire. A welding lamp area is formed by a positive solder joint and a negative solder joint opposite to the positive solder joint. An LED lamp bead is attached to a front or a side of the welding lamp area. The first disconnection points disposed on the positive wire are staggered with the second disconnection points disposed on the negative wire. A stagger distance is formed between each first disconnection point and each corresponding second disconnection point, such that LED lamp beads disposed between the positive wire and the negative wire are serial-parallel connected. A first lead is connected with the positive wires in parallel at a head end of the positive wire. A second lead is connected in parallel with the negative wires at a tail end of the negative wire. The first lead and the second lead are connected with a connecting lug. The light string is detachably connected to another light string through the connecting lug, so that the number of the light string is adjusted based on needs

Conventional LED lamp beads are arranged equidistantly to form a parallel connection, however, in the present disclosure, the positive solder joints and the negative solder joints are stagger and separate from each other between rows and columns, so that the LED lamp beads between the positive wire and the negative wire are serial-parallel connected. Thus, the light string can be used under high voltage.

Furthermore, the stagger distance is at least a distance between two adjacent positive solder joints or at least a distance between two adjacent negative solder joints.

Furthermore, the positive wire and the negative wire are wrapped by light-transmitting paste.

Furthermore, the LED lamp beads are surface mounted device (SMD) LED lamps.

The present disclosure further provides a method of manufacturing the light string with multiple parallel wires. The method of manufacturing the light string with multiple parallel wires comprises:

step 1: arranging wire coil on a pay-off wheel; wounding a free end of the wire coil on a pay-off pendulum rod of the pay-off wheel; sending the free end of the wire coil into a stripping mechanism by the pay-off pendulum rod; dividing the wire coil into a positive wire and negative wire at equal intervals by a stripping mechanism; processing the positive wire and negative wire to expose the positive wire and the negative wires to form positive solder joints and negative solder joints by a flattening and peeling mechanism;

step 2: pasting solder paste on surfaces of the positive solder joints and surfaces of the negative solder joints by a solder pasting machine;

step 3: welding two lamp pins of each SMD LED lamp bead to a positive solder joint and a negative solder joint on a fixture respectively by an LED lamp bead SMD device;

step 4: checking whether there is a defective lamp bead after welding, if yes, performing online maintenance;

step 5: packaging LED lamp beads, the positive solder joints, the negative solder joints in a light-transmitting paste and solidifying the light-transmitting paste by UV light;

step 6: breaking the positive wire and the negative wire in stagger to form a plurality of first disconnection points and a plurality of second disconnection points; wherein the first disconnection points and the second disconnection points are up-and-down staggered;

step 7: packaging the first disconnection points and the second disconnection points in the light-transmitting paste and solidifying the light-transmitting paste by the UV light to complete the manufacturing of the light string; and

step 8: taking up wires of the light string.

By setting the first disconnection points and the second disconnection points, a circuit connecting mode that two wires are connected in parallel, three wires are connected in parallel, or four wires are connected in parallel are realized. The circuit connecting mode that two wires are connected in parallel is configured to realize a use of the light string under 3V low voltage. The circuit connecting mode that three wires are connected in parallel is configured to realize that multiple light strings are able to be connected in series or parallel under high/low voltage. The circuit connecting mode that the four wires are connected in parallel is configured to realize the use of the light string under high and low voltage, and multiple light strings are able to be connected in series or parallel infinitely.

Furthermore, before step 4, connecting the positive wire and the negative wire to a power source to detect a lighting state of each LED lamp bead.

The present disclosure provides a device for manufacturing the light string with multiple parallel wires. The device comprises a frame. A wire pay-off device, a stripping mechanism separating parallel bonded wires, a flattening and peeling mechanism, an LED lamp bead SMD device, a solder pasting machine, a point breaking mechanism, a wire take-up device, a paste pasting mechanism, a UV light irradiation mechanism are disposed on the frame from left to right. The above-mentioned mechanism structure is common knowledge that known to those skilled in the art, which would not be discussed in detail.

The lamp string of the present disclosure is applied to both low voltage power supply and high voltage power supply, and has good versatility. The LED lamp beads are attached to the positive wire and negative wire and the LED lamp beads are first connected in parallel and then connected in series, so that multiple light strings are able to be connected in series infinitely, and the current flowing through each light string is stable to ensure that brightness of each LED lamp bead is consistent. Further, a manufacturing process of the light string of the present disclosure is simple and the production of the light string is completed by mechanical equipment, which realize automated production of the light string, reduces labor costs, reduces labor intensity of workers, and improves production efficiency.

The present disclosure solves problems that many LED lamp beads of the conventional light string need to be connected in series, and also solves a limitation that power of the light strings cannot be set arbitrarily. When the light string of the present disclosure is under high voltage, the current of each series-connected LED lamp beads is small, which reduces power dissipation. The LED lamp beads of the present disclosure constant current through series-parallel connection, which has good consistency, greatly reduce costs, and is simple in production process.

### BRIEF DESCRIPTION OF DRAWINGS

FIG. 1 is a circuit diagram of a light string with three parallel wires according to embodiment 1 of the present disclosure.

FIG. 2 is a circuit diagram of a light string with four parallel wires according to embodiment 2 of the present disclosure.

FIG. 3 is a circuit diagram of a light string with four parallel wires according to embodiment 3 of the present disclosure.

FIG. 4 is a circuit diagram of a light string with two parallel wires.

### DETAILED DESCRIPTION

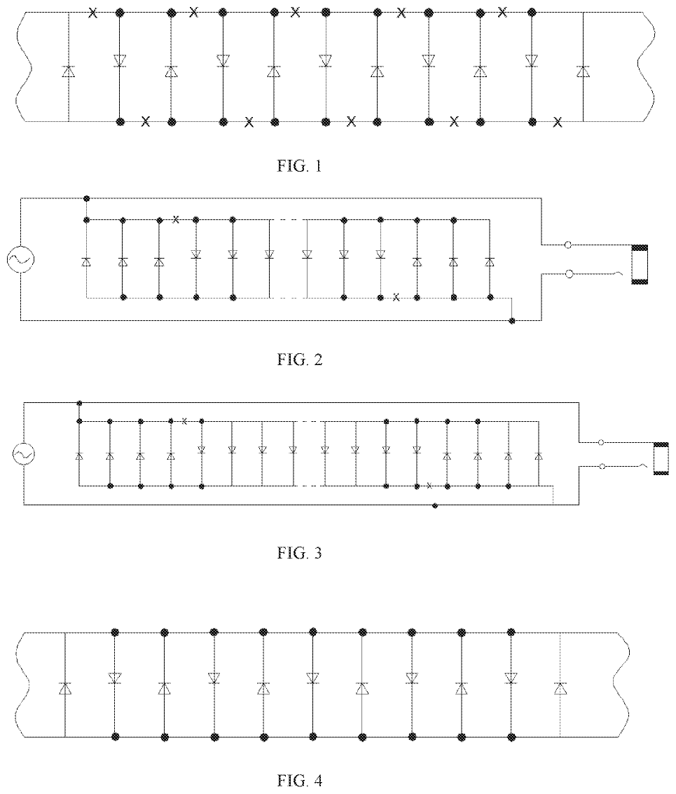

As shown in FIGS. 1-4, the present disclosure provides a holiday decoration light string with multiple parallel wires. The light string is suitable for a 3V power supply, a 110V power supply or a 220V power supply.

The light string comprises a positive wire disposed axially and a negative wire disposed in parallel with the positive wire. A plurality of positive solder joints and first disconnection points are disposed on the positive wire. A plurality of negative solder joints corresponding to the positive solder joints and second disconnection points corresponding to the first disconnection points are disposed on the negative wire. A welding lamp area is formed by a positive solder joint and a negative solder joint opposite to the positive solder joint. An LED lamp bead is attached to a front or a side of the welding lamp area. The first disconnection points disposed on the positive wire are staggered with the second disconnection points disposed on the negative wire. The first disconnection points and the second disconnection points are up-and-down staggered and a stagger distance is formed between each first disconnection point and each corresponding second disconnection point, such that LED lamp beads disposed between the positive wire and the negative wire are serial-parallel connected. The LED lamp beads are attached to a front of the welding lamp area between the positive wire and the negative wire, that is, a connecting surface of each LED lamp bead is parallel to the positive wire and the negative wire, so that the LED lamp beads are horizontally disposed between the positive wire and the negative wire. At this time, light irradiation range of the LED lamp beads is between 0-120 degrees, and light intensity in other directions is weak. In another embodiment, each LED lamp bead is attached to a side of the welding lamp area between the positive wire and the negative lead, that is, the connecting surface of each LED lamp bead is perpendicular to the positive wire and the negative wire, so that each LED lamp bead is vertically disposed between the positive wire and the negative wire. At this time, the light irradiation range of the LED lamp beads is 360 degrees, that is, the brightness from any directions is consistent.

Conventional LED lamp beads are arranged equidistantly to form a parallel connection, however, in the present disclosure, the positive solder joints and the negative solder joints are dislocated and separate from each other between rows and columns, so that the LED lamp beads between the positive wire and the negative wire are serial-parallel connected. Thus, the light string can be used under high voltage.

In one embodiment, the stagger distance is at least a distance between two adjacent positive solder joints or at least a distance between two adjacent negative solder joints.

In one embodiment, the positive wire and the negative wire are two parallel wires. The positive wire and the negative wire are wrapped by light-transmitting paste.

In one embodiment, the LED lamp beads are surface mounted device (SMD) LED lamps and the LED lamp beads are used under a voltage ranges from 2-6V.

In one embodiment, a first lead is connected with the positive wires in parallel at a head end of the positive wire. A second lead is connected in parallel with the negative wires at a tail end of the negative wire. The first lead and the second lead are connected with a connecting lug. The light string is detachably connected to another light string through the connecting lug, so that the number of the light string is adjusted based on needs

The present disclosure further provides a method of manufacturing the light string with multiple parallel wires. The method comprises

Step 1: arranging wire coil on a pay-off wheel; wounding a free end of the wire coil on a pay-off pendulum rod of the pay-off wheel; sending the free end of the wire coil into a stripping mechanism by the pay-off pendulum rod; dividing the wire coil into a positive wire and negative wire at equal intervals by a stripping mechanism; processing the positive wire and negative wire to expose the positive wire and the negative wires to form positive solder joints and negative solder joints by a flattening and peeling mechanism;

Step 2: pasting solder paste on surfaces of the positive solder joints and surfaces of the negative solder joints by a solder pasting machine;

Step 3: welding two lamp pins of each SMD LED lamp bead to a positive solder joint and a negative solder joint on a fixture respectively by an LED lamp bead SMD device;

Step 4: checking whether there is a defective lamp bead after welding, if yes, performing online maintenance;

Step 5: packaging LED lamp beads, the positive solder joints, the negative solder joints in a light-transmitting paste and solidifying the light-transmitting paste by UV light;

Step 6: breaking the positive wire and the negative wire in stagger to form a plurality of first disconnection points and a plurality of second disconnection points; wherein the first disconnection points and the second disconnection points are up-and-down staggered;

Step 7: packaging the first disconnection points and the second disconnection points in the light-transmitting paste and solidifying the light-transmitting paste by the UV light to complete the manufacturing of the light string; and

Step 8: taking up wires of the light string.

In one embodiment, before step 4, the method further comprises connecting the positive wire and the negative wire to a power source to detect a lighting state of each LED lamp bead.

The present disclosure provides a device for manufacturing the light string with multiple parallel wires. The device comprises a frame. A wire pay-off device, a stripping mechanism separating parallel bonded wires, a flattening and peeling mechanism, an LED lamp bead SMD device, a solder pasting machine, a point breaking mechanism, a wire take-up device, a paste pasting mechanism, a UV light irradiation mechanism are disposed on the frame from left to right. The above-mentioned mechanism structure is common knowledge that known to those skilled in the art, which would not be discussed in detail.

### Embodiment 1

As shown in FIG. 1, the present disclosure provides a method of manufacturing a holiday decoration light string with three parallel wires that is suitable for a 3V power supply, a 110V power supply or a 220V power supply. The method comprises

Step 1: arranging wire coil on a pay-off wheel; wounding a free end of the wire coil on a pay-off pendulum rod of the pay-off wheel; sending the free end of the wire coil into a stripping mechanism by the pay-off pendulum rod; dividing the wire coil into a positive wire and negative wire at equal intervals by a stripping mechanism; processing the positive wire and negative wire to expose the positive wire and the negative wires to form positive solder joints and negative solder joints by a flattening and peeling mechanism;

Step 2: pasting solder paste on surfaces of the positive solder joints and surfaces of the negative solder joints by a solder pasting machine;

Step 3: welding two lamp pins of each of SMD LED lamp beads to a positive solder joint and a negative solder joint on a fixture respectively by an LED lamp bead SMD device; wherein the LED lamp beads are divided into a group of odd LED lamp beads and another group of even LED lamp beads. A setting direction of odd LED lamp beads is opposite to a setting direction of the even LED lamp beads. At this time, the LED lamp beads, the positive wire, and the negative wire form a parallel circuit;

Step 4: connecting the positive wire and the negative wire to a power source to detect a lighting state of each LED lamp bead;

Step 5: packaging LED lamp beads, the positive solder joints, the negative solder joints in a light-transmitting paste and solidifying the light-transmitting paste by UV light;

Step 6: breaking the positive wire and the negative wire in stagger to form a plurality of first disconnection points and a plurality of second disconnection points (the label “X” in the drawings represents a disconnection point); wherein the first disconnection points and the second disconnection points are up-and-down staggered;

In the embodiment, a stagger distance is a distance between two positive solder joints or a distance between two negative solder joints.

Step 7. packaging the first disconnection points and the second disconnection points in the light-transmitting paste and solidifying the light-transmitting paste by the UV light to complete the manufacturing of the light string; and

Step 8: taking up wires of the light string.

### Embodiment 2

As shown in FIG. 2, the present disclosure provides a method of manufacturing a holiday decoration light string with four parallel wires that is suitable for a 3V power supply, a 110V power supply, or a 220V power supply. The method comprises

Step 1: arranging wire coil on a pay-off wheel; wounding a free end of the wire coil on a pay-off pendulum rod of the pay-off wheel; sending the free end of the wire coil into a stripping mechanism by the pay-off pendulum rod; dividing the wire coil into a positive wire and negative wire at equal intervals by a stripping mechanism; processing the positive wire and negative wire to expose the positive wire and the negative wires to form positive solder joints and negative solder joints by a flattening and peeling mechanism;

Step 2: pasting solder paste on surfaces of the positive solder joints and surfaces of the negative solder joints by a solder pasting machine;

Step 3: welding two lamp pins of each of thirty-six SMD LED lamp beads to a positive solder joint and a negative solder joint on a fixture respectively by an LED lamp bead SMD device; wherein the thirty-six LED lamp beads are divided into twelve groups; wherein each group comprises three LED lamp beads; the LED lamp beads in a same group are arranged in a same direction, and the direction of odd groups of LED lamp beads is opposite to the direction of even groups of LED lamp beads;

In the embodiment, the number of the LED lamp beads is not limited, it should be understood that the number of the LED lamp beads would be times of a sum of the odd group and the even group of the LED lamp beads.

Step 4: connecting the positive wire and the negative wire to a power source to detect a lighting state of each LED lamp bead;

Step 5: packaging LED lamp beads, the positive solder joints, the negative solder joints in a light-transmitting paste and solidifying the light-transmitting paste by UV light;

Step 6: breaking the positive wire and the negative wire in stagger to form a plurality of first disconnection points and a plurality of second disconnection points (the label “X” in the drawings represents a disconnection point); wherein the first disconnection points and the second disconnection points are up-and-down staggered.

In the embodiment, a stagger distance is a distance between three positive solder joints or a distance between three negative solder joints.

Step 7. packaging the first disconnection points and the second disconnection points in the light-transmitting paste and solidifying the light-transmitting paste by the UV light to complete the manufacturing of the light string; and

Step 8: taking up wires of the light string.

### Embodiment 3

As shown in FIG. 3, the present disclosure provides a method of manufacturing a holiday decoration light string with four parallel wires that is suitable for 3V, 110V or 220V power supply. The method comprises

Step 1: arranging wire coil on a pay-off wheel; wounding a free end of the wire coil on a pay-off pendulum rod of the pay-off wheel; sending the free end of the wire coil into a stripping mechanism by the pay-off pendulum rod; dividing the wire coil into a positive wire and negative wire at equal intervals by a stripping mechanism; processing the positive wire and negative wire to expose the positive wire and the negative wires to form positive solder joints and negative solder joints by a flattening and peeling mechanism;

Step 2: pasting solder paste on surfaces of the positive solder joints and surfaces of the negative solder joints by a solder pasting machine;

Step 3: welding two lamp pins of each of seventy-two SMD LED lamp beads to a positive solder joint and a negative solder joint on a fixture respectively by an LED lamp bead SMD device; wherein the seventy-two LED lamp beads are divided into eighteen groups; wherein each group comprises four LED lamp beads; the LED lamp beads in a same group are arranged in a same direction, and the direction of odd groups of LED lamp beads is opposite to the direction of even groups of LED lamp beads;

Step 4: connecting the positive wire and the negative wire to a power source to detect a lighting state of each LED lamp bead;

Step 5: packaging LED lamp beads, the positive solder joints, the negative solder joints in a light-transmitting paste and solidifying the light-transmitting paste by UV light;

Step 6: breaking the positive wire and the negative wire in stagger to form a plurality of first disconnection points and a plurality of second disconnection points (the label “X” in the drawings represents a disconnection point); wherein the first disconnection points and the second disconnection points are up-and-down staggered;

In the embodiment, a stagger distance is a distance between four positive solder joints or a distance between four negative solder joints.

Step 7: packaging the first disconnection points and the second disconnection points in the light-transmitting paste and solidifying the light-transmitting paste by the UV light to complete the manufacturing of the light string; and

Step 8: taking up wires of the light string.

In the present disclosure, the LED lamp beads are disposed on the wire coil in series, or twelve groups of LED lamp beads disposing on the wire coil are connected in series where each group comprises three LED lamp beads connected in parallel, or eighteen groups of LED lamp beads disposed on the wire coil are connected in series where each group comprises four LED lamp beads connected in parallel, thus, the lamp string of the present disclosure is suitable for both low-voltage power supplies and high-voltage power supplies, and has good versatility. Further multiple lamp strings could be connected in series infinitely, and the current flowing through each LED lamp bead is stable, so that the brightness of the LED lamp beads is consistent. In addition, since the lamp beads are disposed on front/sides of the wire coil, users are able to choose different light strings according to their decoration needs to achieve better visual effects. Although the light string of the present disclosure is realized by setting the disconnection points, there is no such designs in the prior art, which is not a simple idea of realizing the circuit disconnection.

The preparation process of the light string of the present disclosure is simple, and the production is completed by mechanical equipment, which realizes the automatic production of the light string, reduces labor costs, reduces labor intensity, effectively improves production efficiency, and improves the quality of the finished light string. The above disclosure has a wide range of applications. For example, the light string could be used in lighting engineering, home furnishing, holiday decoration, gift production, emergency equipment production, security facility production, handicrafts, water pipe light production, etc.

The above embodiments are only a description of the optional embodiments of the present disclosure, and do not intend to limit the scope of the present disclosure. Without departing from the spirit of the present disclosure, various modifications and changes made by those ordinary skilled in the art to the technical solutions of the present disclosure shall fall within the protection scope determined by the claims of the present disclosure.

1. A light string with multiple parallel wires, comprising
a positive wire disposed axially; and
a negative wire disposed in parallel with the positive wire
wherein a plurality of positive solder joints and first disconnection points are disposed on the positive wire; a plurality of negative solder joints corresponding to the positive solder joints and second disconnection points corresponding to the first disconnection points are disposed on the negative wire; and a welding lamp area is formed by a positive solder joint and a negative solder joint opposite to the positive solder joint; an LED lamp bead is attached to a front or a side of the welding lamp area; the first disconnection points disposed on the positive wire are staggered with the second disconnection points disposed on the negative wire; and a stagger distance is formed between each first disconnection point and each corresponding second disconnection point, such that LED lamp beads disposed between the positive wire and the negative wire are serial-parallel connected; the LED lamp beads, the positive solder joints, the negative solder joints, the first disconnection points, and the second disconnection points are wrapped by isolation paste;
wherein a first lead is connected with the positive wires in parallel at a head end of the positive wire; and a second lead is connected in parallel with the negative wires at a tail end of the negative wire; the first lead and the second lead are connected with a connecting lug; the light string is detachably connected to another light string through the connecting lug, so that the number of the light string is adjusted based on needs.

2. The light string with multiple parallel wires according to claim 1, wherein the stagger distance is at least a distance between two adjacent positive solder joints or at least a distance between two adjacent negative solder joints.

3. The light string with multiple parallel wires according to claim 1, wherein the positive wire and the negative wire are wrapped by light-transmitting paste.

4. The light string with multiple parallel wires according to claim 1, wherein the
LED lamp beads are surface mounted device (SMD) LED lamps.

5. A method of manufacturing a light string with multiple parallel wires, comprising:
step 1: arranging wire coil on a pay-off wheel; wounding a free end of the wire coil on a pay-off pendulum rod of the pay-off wheel; sending the free end of the wire coil into a stripping mechanism by the pay-off pendulum rod; dividing the wire coil into a positive wire and negative wire at equal intervals by a stripping mechanism; processing the positive wire and negative wire to expose the positive wire and the negative wires to form positive solder joints and negative solder joints by a flattening and peeling mechanism;
step 2: pasting solder paste on surfaces of the positive solder joints and surfaces of the negative solder joints by a solder pasting machine;
step 3: welding two lamp pins of each SMD LED lamp bead to a positive solder joint and a negative solder joint on a fixture respectively by an LED lamp bead SMD device;
step 4: checking whether there is a defective lamp bead after welding, if yes, performing online maintenance;
step 5: packaging LED lamp beads, the positive solder joints, the negative solder joints in a light-transmitting paste and solidifying the light-transmitting paste by UV light;
step 6: breaking the positive wire and the negative wire in stagger to form a plurality of first disconnection points and a plurality of second disconnection points; wherein the first disconnection points and the second disconnection points are up-and-down staggered;
step 7: packaging the first disconnection points and the second disconnection points in the light-transmitting paste and solidifying the light-transmitting paste by the UV light to complete the manufacturing of the light string; and
step 8: taking up wires of the light string.

6. The method of manufacturing the light string with multiple parallel wires according to claim 5, wherein before step 8, connecting a first lead in parallel with the positive wire at a head end of the positive wire and connecting a second lead in parallel with the negative wire at a tail end of the negative wire, electrically connecting the first lead and the second lead with a connecting lug, so that the light string forms a four-parallel connection.

7. The method of manufacturing the light string with multiple parallel wires according to claim 5, wherein before step 4, connecting the positive wire and the negative wire to a power source to detect a lighting state of each LED lamp bead.

8. An application, comprising a light string with multiple parallel wires; wherein the light string is configured to make a water pipe light, an outdoor lighting device, a garden lighting device, a Christmas decoration, or a home decoration.
